(19) United States
(12) Patent Application Publication
(10) Pub. No.: US 2012/0170968 A1
(43) Pub. Date: Jul. 5, 2012

(54) BINDING ASSEMBLY

(75) Inventors: James HENDERSON, Lower Wick (GB); Kester Rudd, Worcester (GB); Hugh Darcy, Thornbury (GB)

(73) Assignee: Fellowes, Inc., Itasca, IL (US)

(21) Appl. No.: 12/984,282

(22) Filed: Jan. 4, 2011

(51) Int. Cl. B42F 13/20

(52) U.S. Cl. 402/36

(57) ABSTRACT

A binder assembly for receiving and retaining articles and that includes a cover comprising a spine portion and at least one cover leaf portion and a first binder element and a second binder element comprising a plurality of first and second retaining fingers, respectively. The first and second binding elements are moveable between 1) an open position wherein articles are permitted to be removed from or mounted to the binder assembly, and 2) a closed position wherein articles mounted to the binder assembly are prevented from being removed. The binder assembly further includes an elongated retainer/lock constructed to releasably attach to the first and second binding elements in the closed position thereof with the spine portion of the cover therebetween for locking the first and second binding elements in the closed position and securing the first and second binding elements to the spine portion of the cover.

### BACKGROUND OF THE INVENTION

1. Field of Invention

The present invention is generally related to a binding assembly for retaining articles, such as paper.

2. Background

Binding mechanisms are generally known in the art to retain sheets of paper or other articles. The binding mechanisms may be provided in books, notebooks, folders, or other components to retain the papers or other articles therein. For example, binders typically include a plurality of rings which can be selectively opened and closed to allow papers to be inserted into and removed from the binder. The plurality of rings typically retain separate back and cover portions therein. Alternatively, the plurality of rings may be fixed to a single cover portion. In addition, some existing binding mechanisms may comprise components that are difficult to align and engage to retain the articles therein. Thus, these existing binding mechanisms may be difficult to operate and expensive to manufacture. Furthermore, the existing binding mechanisms may lack secure connections, versatility, and/or modularity.

### SUMMARY OF THE INVENTION

One aspect of the invention provides a binder assembly for receiving and retaining at least one article with holes formed along an edge thereof. The binder assembly includes a cover comprising a spine portion and at least one cover leaf portion and a first binder element comprising a plurality of first retaining fingers. The binder assembly also includes a second binder element comprising a plurality of second retaining fingers. The plurality of first and second retaining fingers are arranged to define a plurality of opposing pairs of the first and second retaining fingers. The first binding element and the second binding element are moveable between 1) an open position wherein ends of the first and second retaining fingers of each pair are disengaged and spaced apart from one another to permit the at least one article to be removed from or mounted to the binder assembly by engaging or disengaging the holes and the first and second retaining fingers, and 2) a closed position wherein the ends of the first and second retaining fingers of each pair are engaged together to prevent the at least one article mounted to the binder assembly from being removed. The binder assembly further includes an elongated retainer/lock constructed to releasably attach to the first and second binding elements in the closed position thereof with the spine portion of the cover therebetween for locking the first and second binding elements in the closed position and securing the first and second binding elements to the spine portion of the cover.

Other objects, features, and advantages of the present invention will become apparent from the following detailed description, the accompanying drawings, and the appended claims.

### BRIEF DESCRIPTION OF THE DRAWINGS

FIG. 1 is a perspective view of binding elements of a binder assembly in accordance with an embodiment;

FIG. 2a is a perspective view of the binding elements of the binder assembly in an unassembled arrangement in accordance with an embodiment;

FIG. 2b is a perspective view of the binding elements of the binder assembly in an open position in accordance with an embodiment;

FIG. 3a is a detailed view of components of the binder assembly in the open position in accordance with an embodiment;

FIG. 3b is a detailed view of the components of the binder assembly in the closed position in accordance with an embodiment;

FIG. 3c is a detailed view of the components of the binder assembly in the closed position in accordance with an embodiment;

FIG. 4a is a detailed view of an end of the binder assembly in accordance with an embodiment;

FIG. 4b is a detailed view of another end of the binder assembly in accordance with an embodiment;

FIG. 5a is a detailed view of the ends of the binder assembly in the closed position in accordance with an embodiment;

FIG. 5b is a detailed view of the ends of the binder assembly in the open position in accordance with an embodiment;

FIG. 6a is a detailed view of the ends of the binder assembly in the open position in accordance with another embodiment;

FIG. 6b is a detailed view of the binder assembly in accordance with the embodiment shown in FIG. 6a;

FIG. 7a is a perspective view of the binding elements and lock/retainer of the binder assembly in accordance with an embodiment;

FIG. 7b is a detailed view of the binding element and the lock/retainer of the binder assembly in accordance with an embodiment;

FIG. 8 is an exploded view of the binder assembly in accordance with an embodiment;

FIG. 9a is a detailed view of a cover and lock/retainer of the binder assembly in accordance with an embodiment;

FIG. 9b is a detailed view of an assembled cover, lock/retainer, and binding elements of the binder assembly in the closed position in accordance with an embodiment;

FIG. 10a is a perspective view of the binder assembly in accordance with an embodiment; and

FIG. 10b is a perspective view of multiple binder assemblies in accordance with an embodiment.

### DETAILED DESCRIPTION OF THE PREFERRED EMBODIMENT(S) OF THE INVENTION

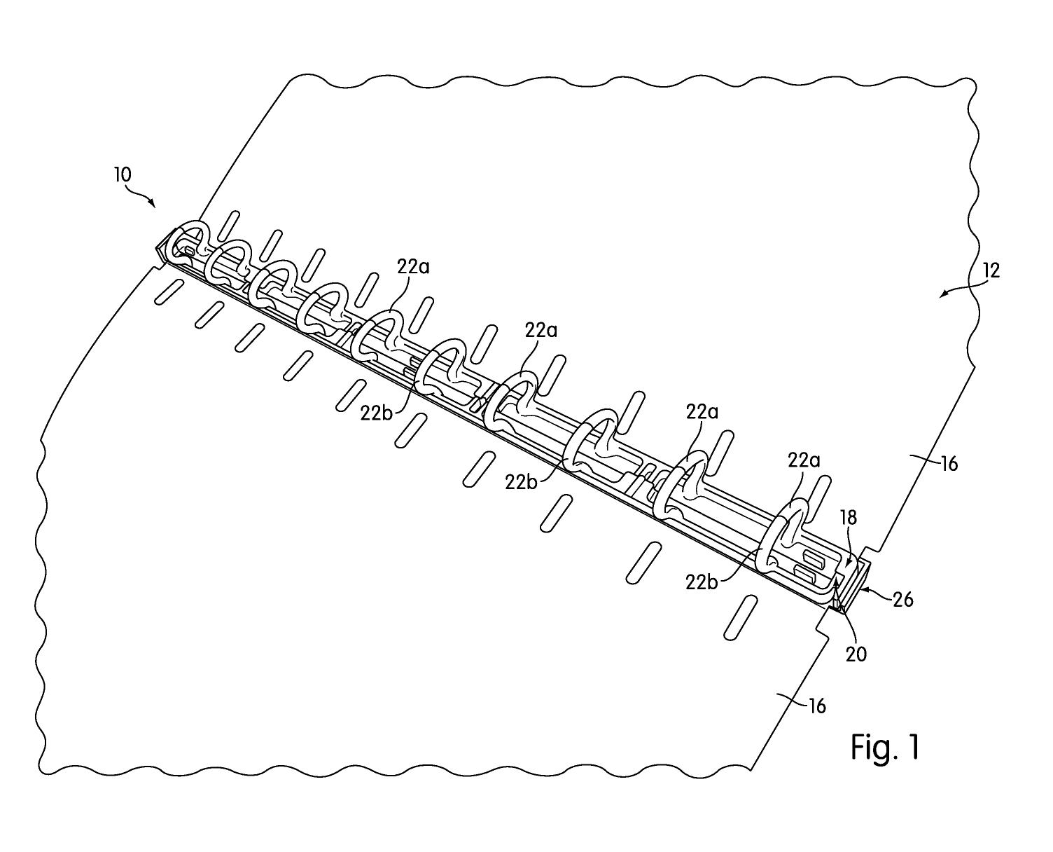

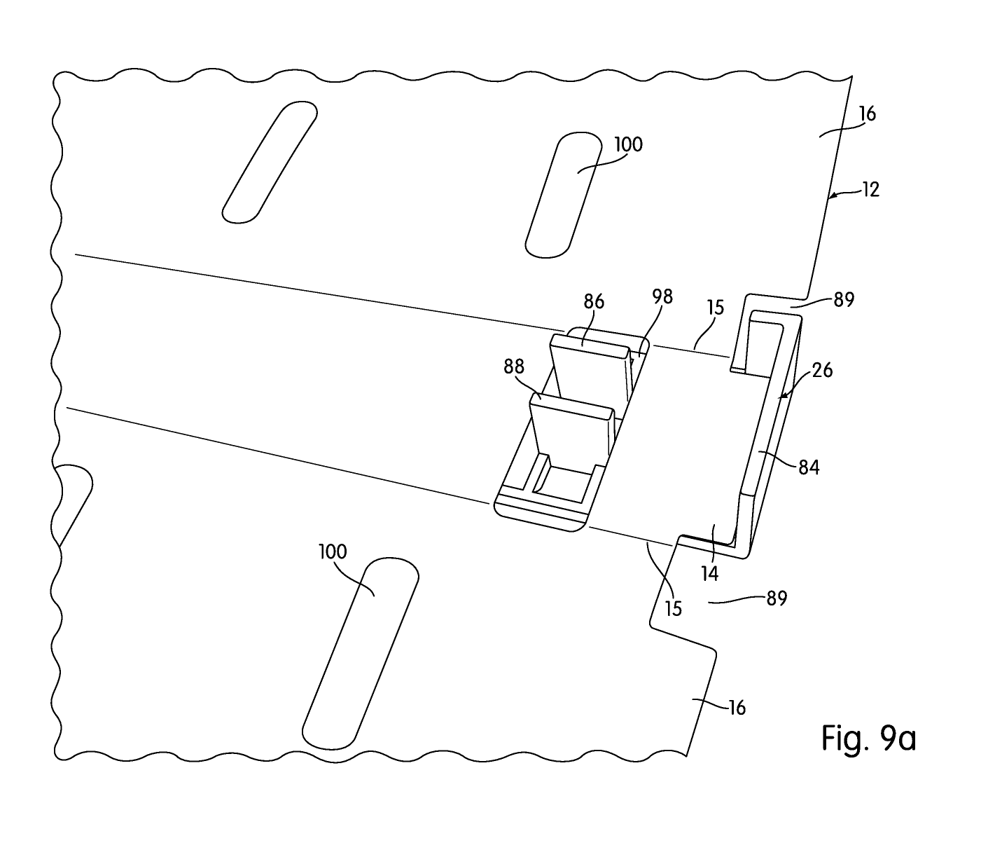

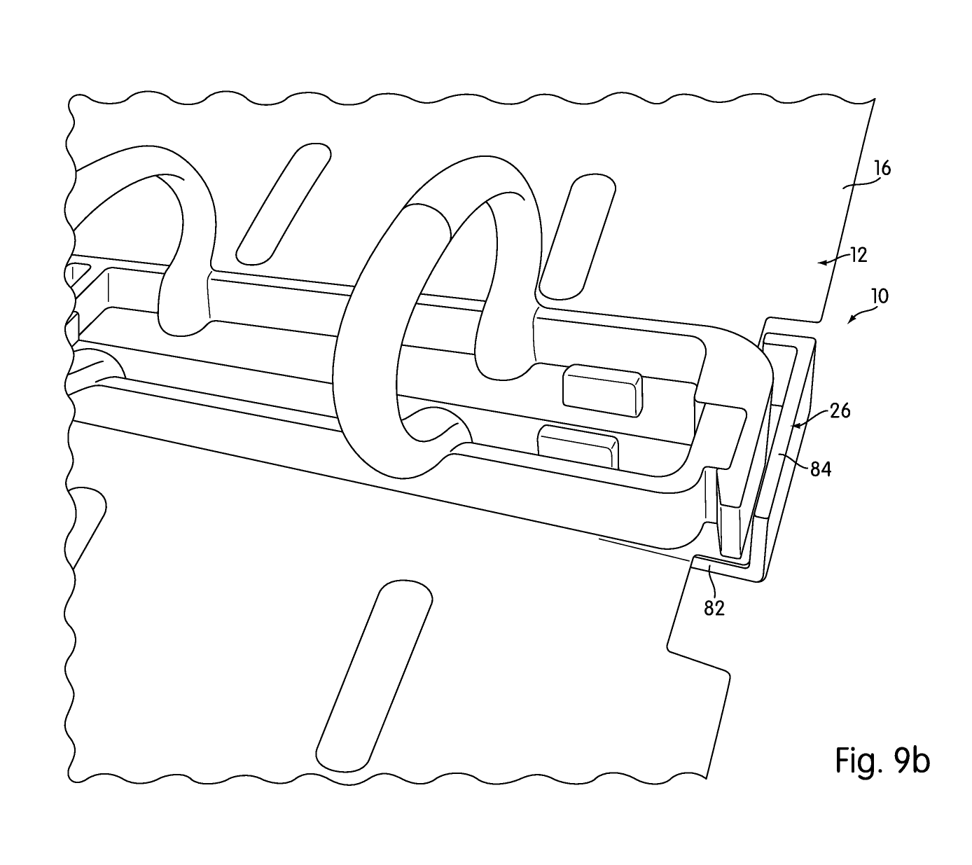

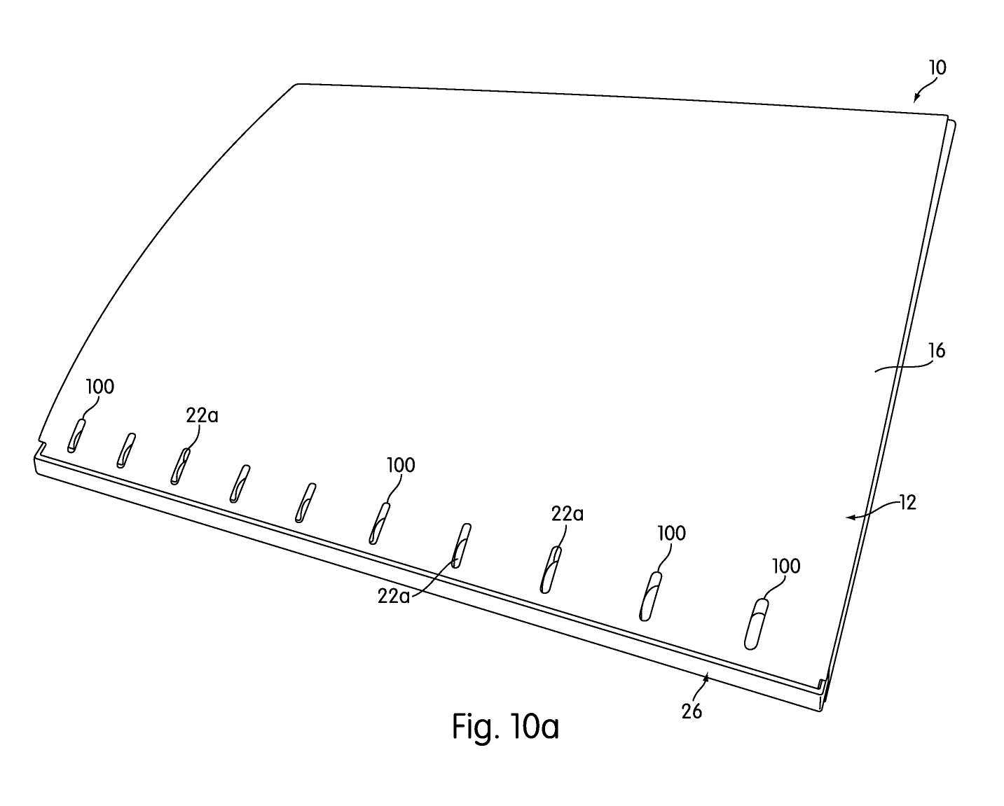

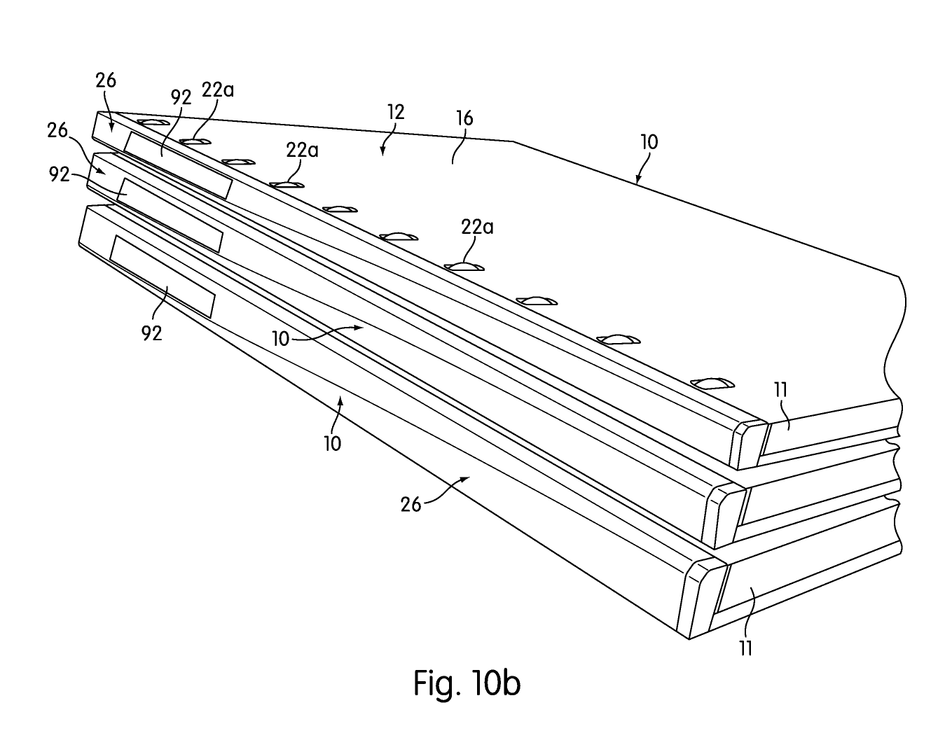

FIG. 1 illustrates an embodiment of a binder assembly 10 for receiving and retaining at least one article with holes formed along an edge thereof. The binder assembly 10 includes a cover 12 having a spine portion 14 (shown in FIG. 9a) and at least one cover leaf portion 16 (two are shown in this embodiment). The cover leaf portions 16 may be integrally formed with the spine portion 14 or may be separate pieces attached to the spine portion 14. A living hinge 15 (see FIG. 9a) may be provided at the connection between the spine portion 14 and the cover leaf portions 16 so as to enable the cover leaf portions 16 to be pivoted relative to the spine portion 14 between an open position (shown in this Figure) wherein access to the articles 11 retained by the binder assembly 10 is permitted, and a closed position wherein access to the articles 11 retained by the binder assembly 10 is prevented (see FIG. 10a). In embodiments where the cover leaf portions 16 and the spine portion 14 are separate components, it is contemplated that other types of hinges may also be used.

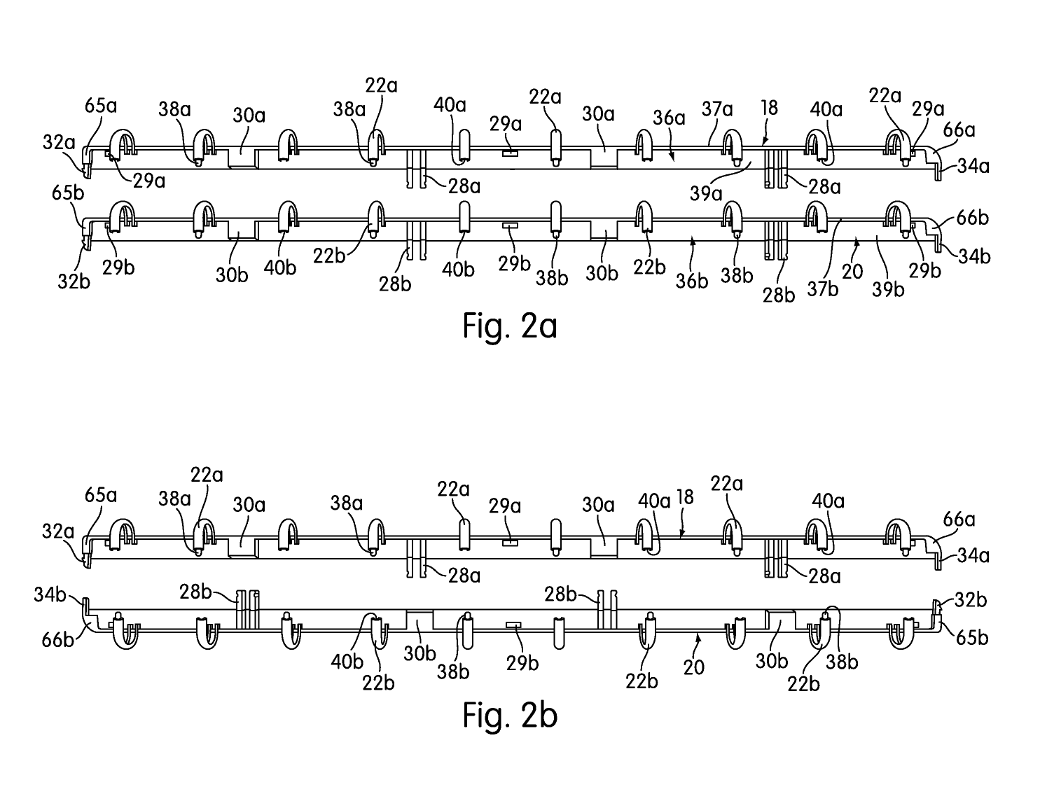

Referring back to FIG. 1, the binder assembly 10 also has a first binder element 18 and a second binder element 20. The first binder element 18 has a plurality of first retaining fingers 22a. The second binder element 20 has a plurality of second retaining fingers 22b. The plurality of first and second retaining fingers 22a, 22b are arranged to define a plurality of opposing pairs of the first and second retaining fingers 22a, 22b. The first binding element 18 and the second binding element 20 are movably mounted together for movement between 1) an open position (see FIG. 2b) wherein ends of the first and second retaining fingers 22a, 22b of each pair are disengaged and spaced apart from one another to permit the at least one article to be removed from or mounted to the binder assembly 10 by engaging or disengaging the holes of the articles with/from the first and second retaining fingers 22a, 22b, and 2) a closed position (see FIG. 2b) wherein the ends of the first and second retaining fingers 22a, 22b of each pair are engaged together to prevent the at least one article 13 from being removed from or inserted into the fingers 22a, 22b of the binder assembly 10. The assembly 10 also includes an elongated retainer/lock 26 constructed to releasably attach to the first and second binding elements 18, 20 in the closed position thereof with the spine portion 14 of the cover 12 therebetween for locking the first and second binding elements 18, 20 in the closed position and for securing the first and second binding elements 18, 20 to the spine portion 14 of the cover 12.

As shown in FIG. 2a, the first binding element 18 includes a main portion 36a having a first end 32a and a second end 34a. In this embodiment, the main portion 36a includes an upper portion 37a and a lower portion 39a. The first and second ends 32a, 34a may extend from the upper portion 37a. The transition between the upper portion 37a and the first and second ends 32a, 34a may be defined by a first corner 65a and a second corner 66a. The plurality of first retaining fingers 22a may be arranged between the first end 32a and the second end 34a.

Similarly, the second binding element 20 includes a main portion 36b having a first end 32b and a second end 34b. In this embodiment, the main portion 36b also includes an upper portion 37b and a lower portion 39b. The first and second ends 32b, 34b may extend from the upper portion 37b. The transition between the upper portion 37b and the first and second ends 32b, 34b may be defined by a first corner 65b and a second corner 66b. The plurality of second retaining fingers 22b may be arranged between the first end 32b and the second end 34b.

In the illustrated embodiment, the first and second retaining fingers 22a, 22b take the form of ring segments. Accordingly, when the first and second binding elements 18, 20 are in the closed position and the first and second retaining fingers 22a, 22b are engaged together, the first and second retaining fingers 22a, 22b form enclosures or rings (see FIG. 1) to prevent the at least one article mounted to the binder assembly 10 from being removed. In this embodiment, the binding elements 18, 20 are provided with ten pairs of opposing first and second retaining fingers 22a, 22b. In one embodiment, the opposing pairs of first and second retaining fingers 22a, 22b are spaced apart at a distance of about 25 mm to 30 mm. It should be appreciated that the number, shape, spacing, and arrangement of the retaining fingers 22a, 22b may be varied in other embodiments to accommodate the spacing of the holes of the articles.

The first and second retaining fingers 22a, 22b may also include either a locating pin 38a, 38b extending therefrom or a locating pin receiving structure 40a, 40b constructed and arranged to engage with the locating pins 38a, 38b. In the illustrated embodiment, alternating first retaining fingers 22a may be provided with the locating pin 38a while the other first retaining fingers 22a are provided with the locating pin receiving structure 40a. Similarly, alternating second retaining fingers 22b may be provided with the locating pin 38b while the other second retaining fingers 22b are provided with the locating pin receiving structure 40b.

As shown in the illustrated embodiment, the binding elements 18, 20 each comprises locking protrusions 28a, 28b, respectively, spaced along the length thereof. Each of the first and second binding elements 18, 20 also comprises protrusion receiving structures 30a, 30b, respectively, spaced along the length thereof. The protrusions 28a, 28b are constructed and arranged to engage with protrusion receiving structures 30a, 30b on the opposing first and second binding elements 18, 20 (see FIG. 2b). In this embodiment, each binding element 18, 20 includes two locking protrusions 28a, 28b and two protrusion receiving structures 30a, 30b. However, this example is not intended to be limiting and it is contemplated that the number and location of the protrusions 28a, 28b and protrusion receiving structures 30a, 30b may vary in other embodiments.

In one embodiment, the first and second binding elements 18, 20 may also be provided with a plurality of openings 29a, 29b, respectively, along the length thereof. In the embodiment shown in FIG. 2a, the first and second binding elements 18, 20 each have three openings 29a, 29b. The openings 29a may be aligned with the openings 29b when the first and second binding elements 18, 20 are in the open position and facing each other, as shown in FIG. 2b. The openings 29a, 29b may be constructed and arranged to receive portions of the retainer/lock 26.

In the embodiment shown in FIG. 2a, the first binding element 18 and the second binding element 20 are constructed and arranged in a similar manner. That is, the fingers 22a, the protrusions 28a, and the protrusion receiving structures 30a of the first binding element 28 are constructed and arranged similarly as those of the second binding element 20. Thus, the first and second binding elements 18, 20 may be inexpensive and easy to manufacture. Any combination or all of the components of the first and second binding elements 18, 20 may be made of plastic material. Any combination or all of the components may also be made of integrally molded plastic. It is contemplated that the components of the first and second binding elements 18, 20 may also be made of other materials or may be separately attached together to form the first and second binding elements 18, 20.

FIG. 2b shows the first and second binding elements 18, 20 facing each other in the open position. Although the first and second binding elements 18, 20 have the same construction and arrangement (as shown in FIG. 2a), the first and second binding elements 18, 20 may be positioned to face each other (e.g., the second binding element 20 may be flipped from its position shown in FIG. 2a) such that the protrusions 28a, 28b of each binder element 18, 20 is aligned with the protrusion receiving structure 30a, 30b of the other binder element 18, 20. In such an arrangement, the first end 32a of the first binder element 18 is aligned with the second end 34b of the second binder element 20, and the second end 34a of the first binder element 18 is aligned with the first end 32b of the second binder element 18. In addition, the locating pins 38a of the first retaining fingers 22a are aligned with the locating pin receiving structures 40b of the second retaining fingers 22b, and the locating pin receiving structures 40a of the first retaining fingers 22a are aligned with the locating pins 38b of the second retaining fingers 22b.

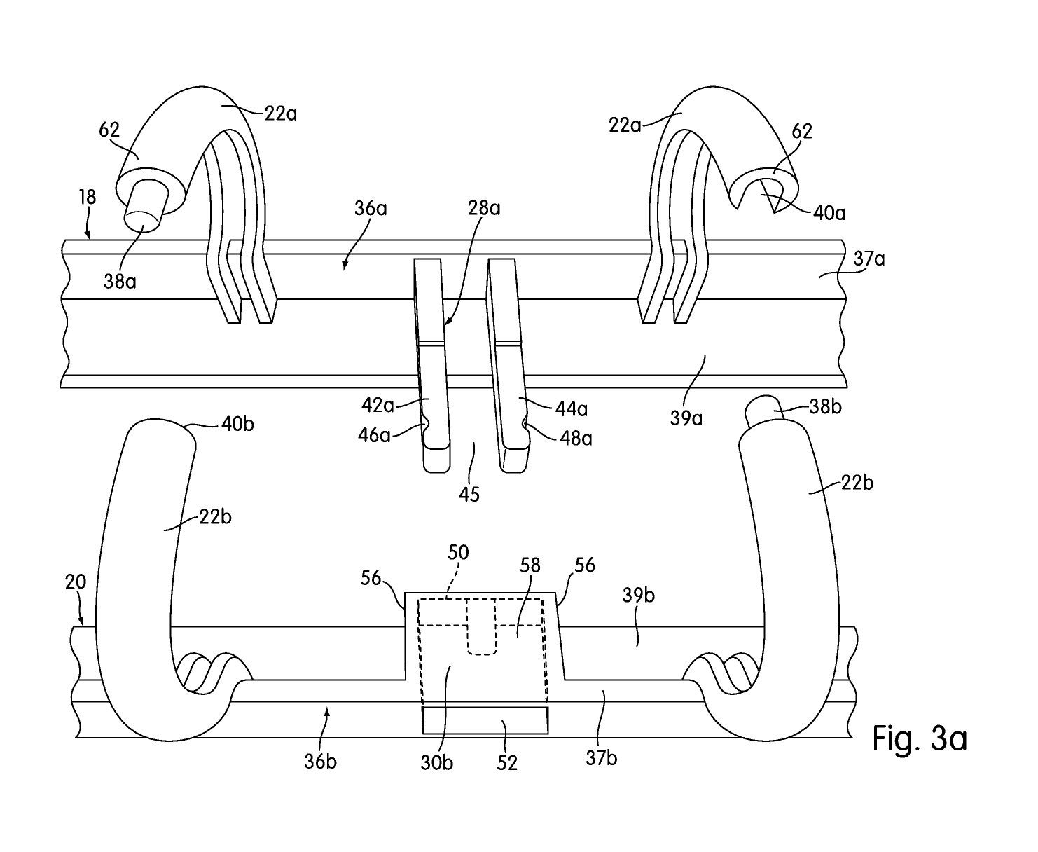

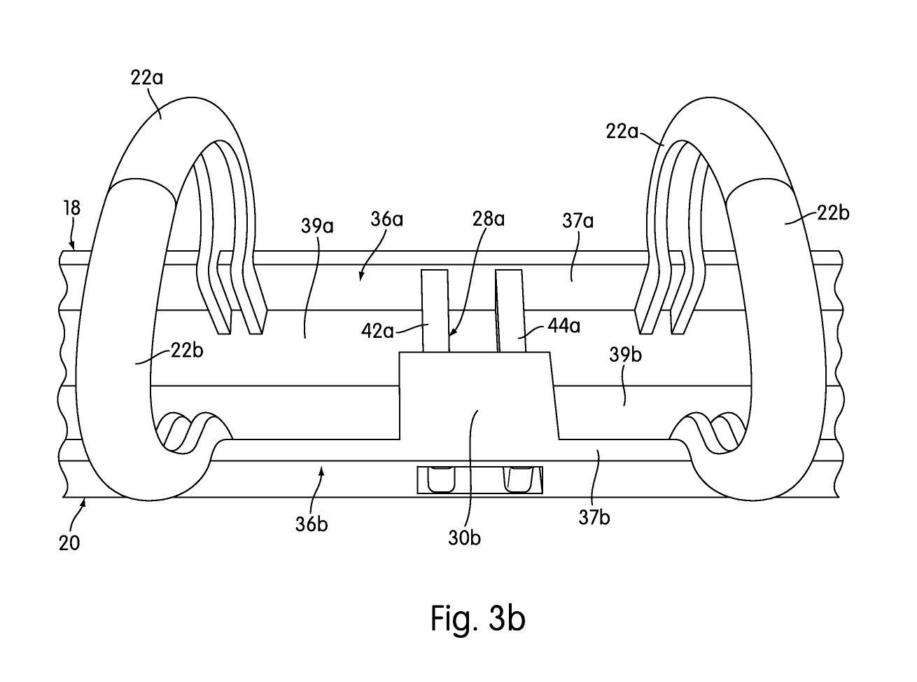

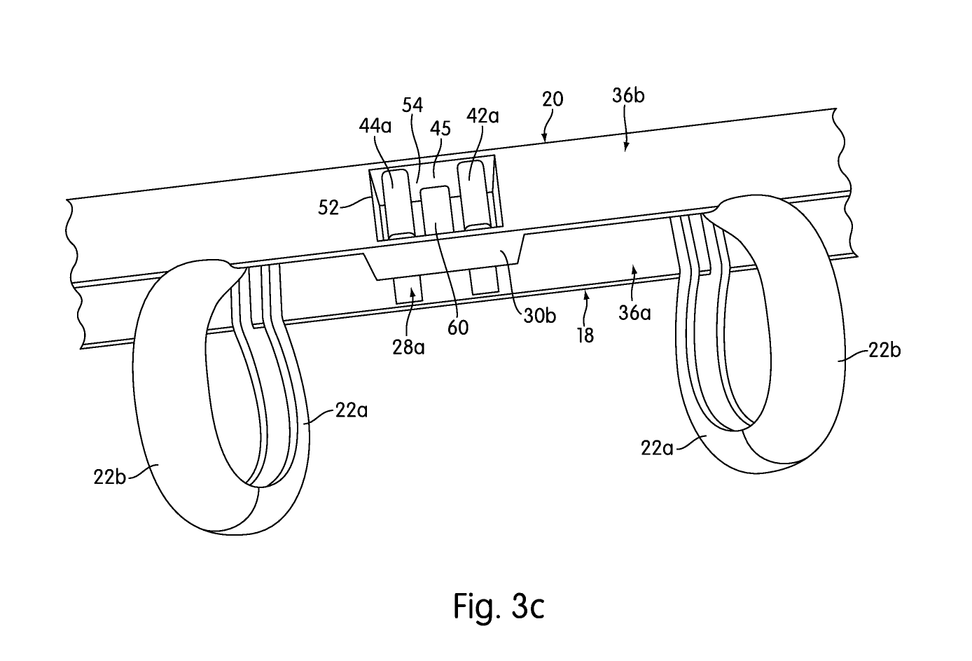

FIG. 3a illustrates the locking protrusion 28a of the first binding element 18 and the protrusion receiving structure 30b of the second binding element 20 in more detail. The locking protrusion 28a includes two prongs 42a, 44a extending from the upper portion 37a. In the illustrated embodiment, the two prongs 42, 44a are generally parallel with a space 45 therebetween. Each prong 42a, 44a may also be provided with an indentation 46a, 48a, respectively, at an end opposite the end attached to the upper portion 37a. The indentation 46a, 48a may be positioned to face away from each other. The locking protrusion 28a may be made of resilient plastic material.

The two prongs 42a, 44a may be constructed and arranged to be received in a front opening 50 formed in the protrusion receiving structure 30b. The protrusion receiving structure 30b may also include a rear opening 52 communicating with the front opening 50 through a space 54 (see FIG. 3c) provided in the protrusion receiving structure 30b. Referring back to FIG. 3a, the front opening 50, the rear opening 52, and the space 54 may be defined by the lower portion 39b and two side walls 56 and an upper wall 58 of the protrusion receiving structure 30b. A divider 60 (see FIG. 3c), taking the form of a vertical structure extending between the upper wall 58 and the lower portion 39b in this embodiment, may be provided in the space 54 of the protrusion receiving structure 30b. Accordingly, the divider 60 may be received in the space 45 between the prongs 42a, 44a when the protrusion 28a is engaged with the protrusion receiving structure 30b, as shown in FIG. 3c. In one embodiment, retaining structures (not shown) may extend from the side walls 56 into the space 54 of the protrusion receiving structure 30b. Thus, the retaining structures may be constructed and arranged to engage with the indentations 46a, 48a provided on the prongs 42a, 44a so as to retain the prongs 42a, 44a of the locking protrusion 28a within the protrusion receiving structure 30b.

As mentioned above, the locking protrusion 28a and protrusion receiving structure 30a of the first binding element 18 may be similarly constructed and arranged as the locking protrusion 28b and the protrusion receiving structure 30b of the second binding element 20. Thus, the locking protrusion 28b of the second binding element 20 may have prongs 42b, 44b with indentations 46b, 48b formed therein. The protrusion receiving structure 30a of the first binding element 20 may also have side walls 56, the rear opening 52, and other similar components as the protrusion receiving structure 30b of the second binding element 20 described above.

Referring back to FIG. 3a, the retaining fingers 22a, 22b may be hollow with a generally arcuate surface. With respect to the retaining fingers 22a, 22b having the locating pin receiving structures 40a, 40b, a front end 62 of the arcuate surface of the retaining fingers 22a, 22b may define the locating pin receiving structures 40a, 40b, which takes the form of openings in this embodiment. With respect to the retaining fingers 22a, 22b having the locating pins 38a, 38b, the locating pin 38a, 38b may be constructed to extend from the front end 62 of the retaining fingers 22a, 22b. In the illustrated embodiment, the locating pins 38a of the retaining fingers 22a are aligned with the locating pin receiving structures 40b of the second retaining fingers 22b, and the locating pin receiving structures 40a of the first retaining fingers 22a are aligned with the locating pins 38b of the second retaining fingers 22b. Accordingly, the locating pin 38a, 38b may be received in the locating pin receiving structures 40a, 40b of the retaining fingers 22a, 22b when the first and second binding elements 18, 20 are engaged, as shown in FIG. 3b. The locating pins 38a, 38b and the locating pin receiving structures 40a, 40b may be constructed and arranged as such to keep the retaining fingers 22a, 22b engaged and aligned, thus preventing articles from being removed from or inserted between the retaining fingers 22a, 22b.

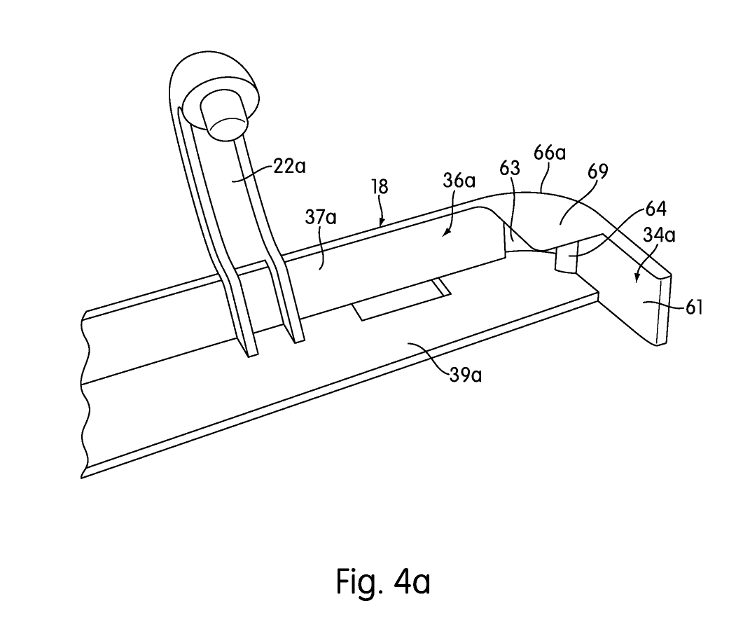

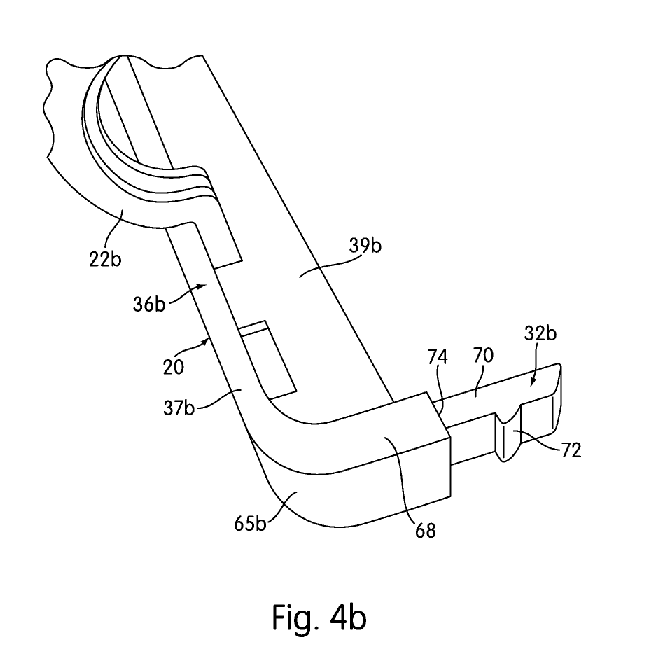

FIG. 4a shows the second end 34a of the first binding element 18 in more detail. As shown in FIG. 4a, the second end 34a may take the form of a lip 61 extending from the upper portion 37a of the main portion 36a. An opening 63 may be provided between the second end 34a and the upper portion 37a of the main portion 36a at the corner 66a. An engaging member, taking the form of a vertical ridge 64 in this embodiment, may be provided near the second corner 66a of the main portion 36a. In addition, an overhang 69 may extend from the second corner 66a above the ridge 64.

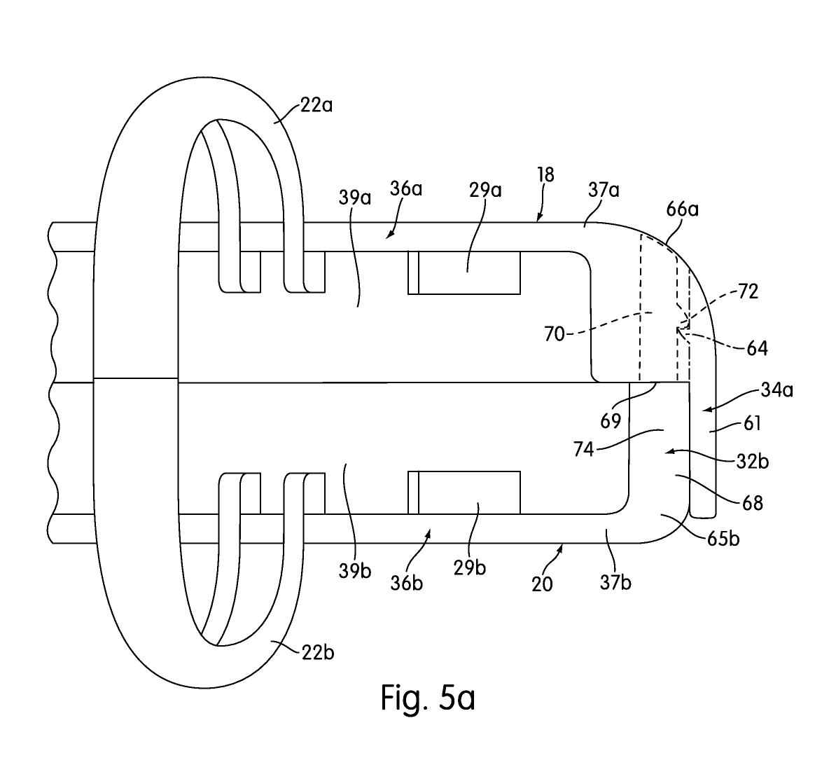

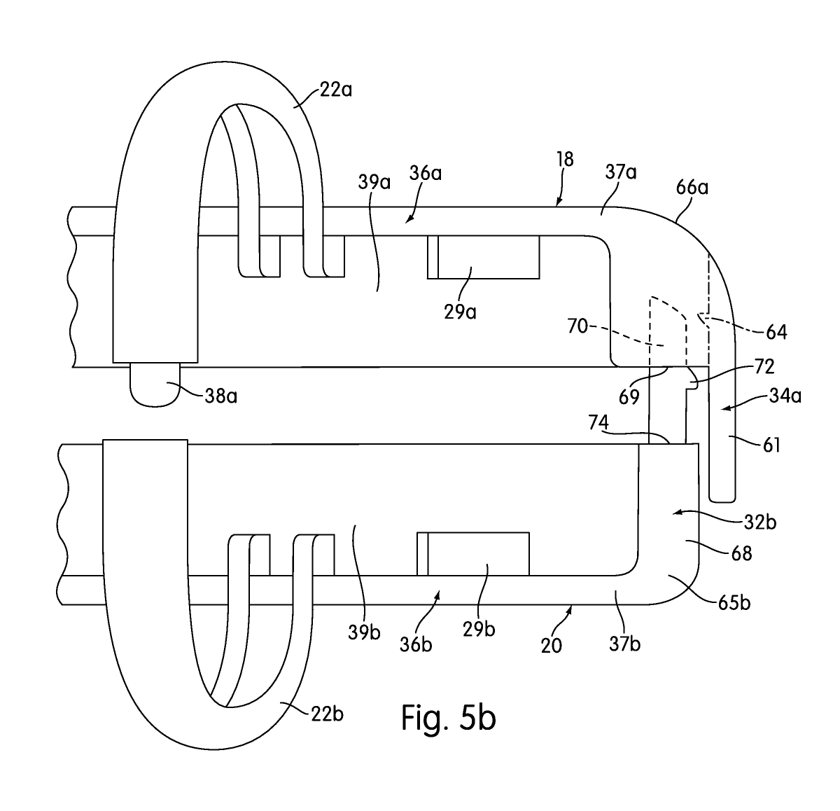

FIG. 4b shows the first end 32b of the second binding element 20 in more detail. As shown in FIG. 4b, the upper portion 37b transitions to the first end 32b near the first corner 65b. The first end 32b includes a side portion 68 and a protruding portion 70 attached to the side portion 68. The protruding portion 70 may have a second engaging member, taking the form of a ridge 72, provided at an end opposite the end attached to the side portion 68. The ridge 72 may be constructed and arranged to engage with the ridge 64 provided on the second end 34a of the first binding element 18 when the first and second binding elements 18, 20 are in the closed position, as shown in FIG. 5a. That is, the ridge 64 of the first binding element 18 may be constructed to abut against the ridge 72 of the second end 32 of the second binding element 20 to prevent disengagement between the first and second ends 32b, 34a. Accordingly, the ridge 64 and the ridge 72 may be considered to be latches used to latch or snap together the first and second ends 32b, 34a of the second and first binding elements 20, 18, respectively. It should be appreciated that the other first and second ends 32a, 34b may also have latches similarly constructed and arranged as the ridges 64, 72 for latching or snapping together the first and second ends 32a, 34b of the first and second binding elements, 18, 20, respectively. In the closed position, a portion of the protruding portion 70 of the second binding element 20 may extend into the opening 63 formed at the corner 66a of the first binding element 18.

In one embodiment, the cross section of the side portion 68 may be larger than the cross section of the protruding portion 70, thus forming a ledge 74 (see FIG. 4b) therebetween. The ledge 74 may be constructed and arranged to abut against the overhang 69 when the first and second binding elements 18, 20 are in the closed position, as shown in FIG. 5a. The first and second ends 32b, 34a may also be made of resilient plastic material. Furthermore, the first end 32a of the first binding element 18 and the second end 34b of the second binding element 20 may be constructed and arranged in a similar manner as the second end 34a of the first binding element 18 and the first end 32b of the second binding element 20, described above.

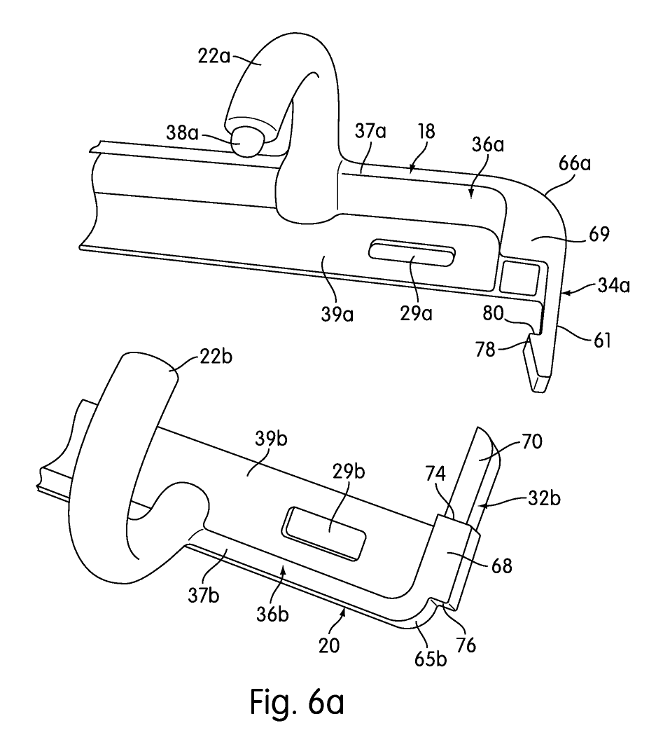

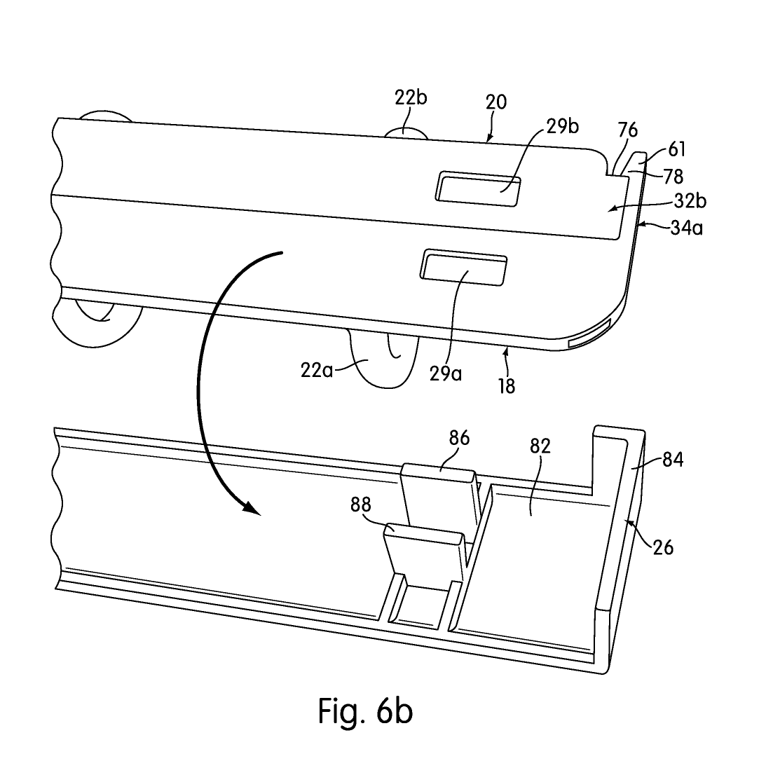

FIG. 6a shows another embodiment of the first and second ends 34a, 32b of the second and first binding elements 20, 18, respectively. In this embodiment, the second end 34a is provided with the lip 61. The lip 61 is provided with the first engaging member, taking the form of a sloped protrusion 78 having a flat surface 80 in this embodiment.

In the illustrated embodiment, the first end 32b may be provided with the side portion 68 and the protruding portion 70 extending from the side portion 68. The ledge 74 is formed between the side portion 68 and the protruding portion 70. The second engaging member, taking the form of a ledge 76 in this embodiment, is formed on the side portion 68 near the corner 65b. The ledge 76 of the first end 32b is constructed and arranged to abut against the flat surface 80 of the sloped protrusion 78 of the second end 34a to prevent disengagement thereof when the first and second binding elements 18, 20 are in the closed position, as shown in FIG. 6b. Alternatively, in one embodiment, the sloped protrusion 78 of the second end 34a may be received in a recess (not shown) formed in the side portion 68 of the first end 32b to prevent disengagement thereof.

FIG. 6b also shows an embodiment of the elongated retainer/lock 26. In this embodiment, the retainer/lock 26 includes a base portion 82 and side portions 84 extending generally upwards from the base portion 82. The retainer/lock 26 includes a pair of spaced apart retaining structures 86, 88. The retaining structures 86, 88 are constructed and arranged to be received in the openings 29a, 29b provided on the first and second binding elements 18, 20 to releasably attach to the first and second binding elements 18, 20 in the closed position thereof, as shown in FIG. 1. That is, the retaining structure 86 is constructed and arranged to engage with the opening 29a of the first binding element 18 and the retaining structure 88 is constructed and arranged to engage with the opening 29b of the second binding element 20. It is contemplated, however, that the arrangement, number, and location of the openings 29a, 29b and retaining structures 86, 88 may vary in other embodiments. In this embodiment, the side portion 84 of the retainer/lock 26 may be constructed and arranged to prevent the first ends 34a, 34b from being disengaged from the 32a, 32b, which will be described in more detail later.

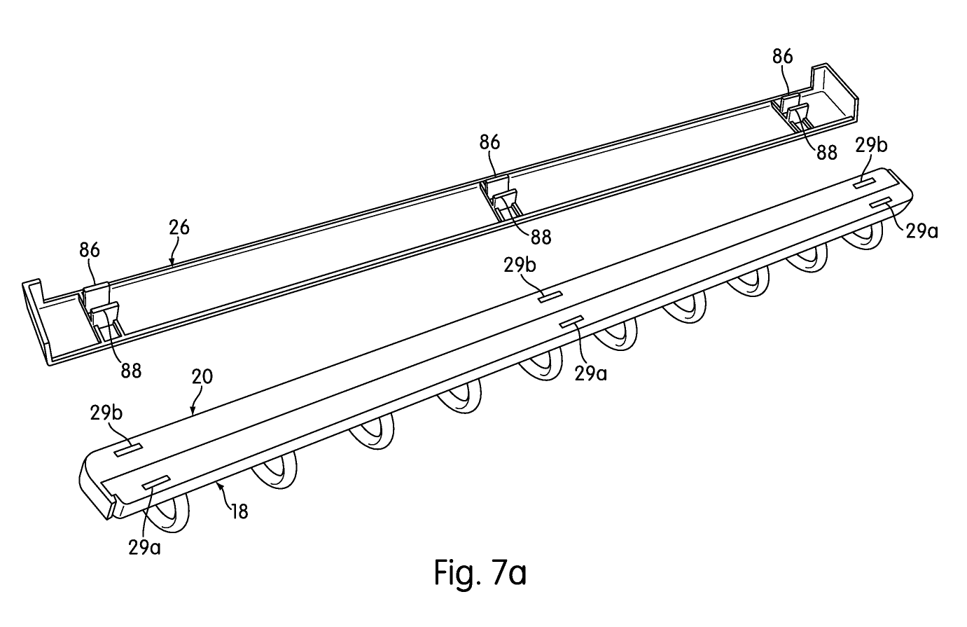

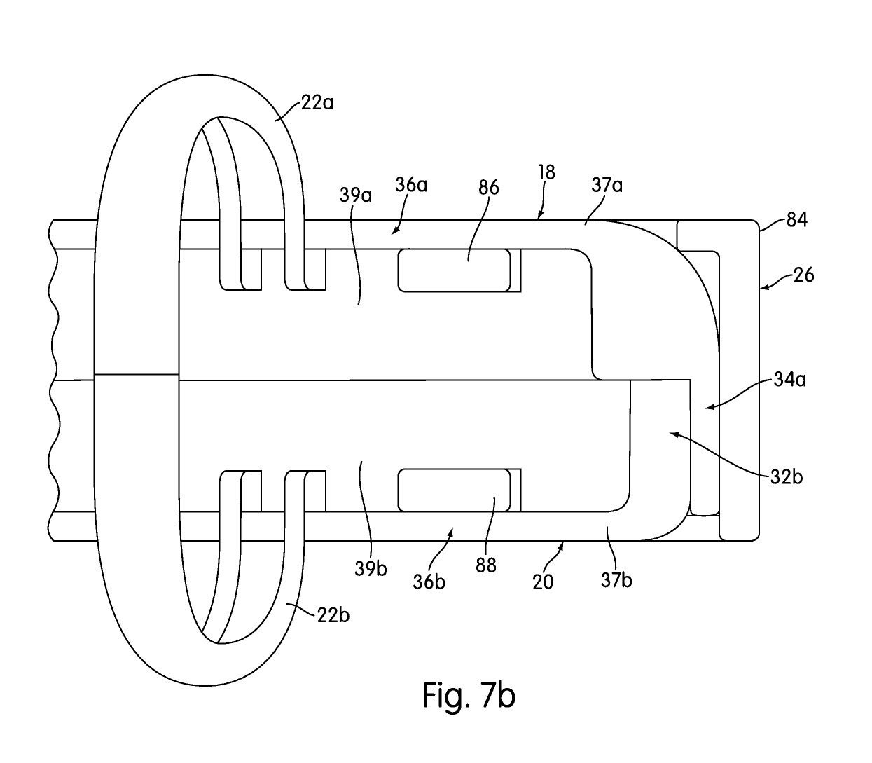

FIG. 7a shows an embodiment of the retainer/lock 26 and the binding elements 18, 20 in the closed position. In this embodiment, three pairs of retaining structures 86, 88 provided on the retainer/lock 26 are constructed and arranged to engage with the three pairs of openings 29a, 29b provided on the first and second binding elements 18, 20. When the first and second binding elements 18, 20 are in the closed position, the pairs of openings 29a, 29b may be aligned with the retaining structures 86, 88. The retaining structures 86, 88 may be provided with teeth or other structures constructed and arranged to grasp onto the lower portion of the 39a, 39b of the first and second binding elements 18, 20 when the retaining structures 86, 88 are received in the openings 29a, 29b, as shown in FIG. 7b. The retaining structures 86, 88 may also be made of resilient plastic material or other resilient materials.

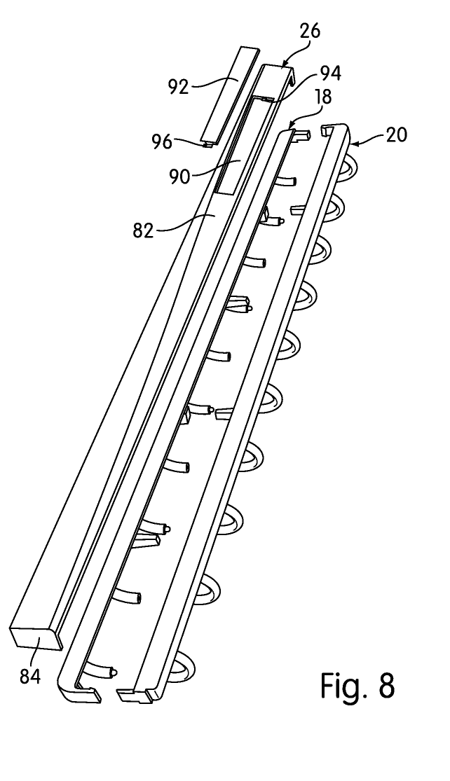

FIG. 8 illustrates the retainer/lock 26 and the first and second binding elements 18, 20 in the open position. The retainer/lock 26 may be provided with a channel 90 on the base portion 82 on a side opposite the first and second retaining structures 86, 88. The channel 90 is constructed and arranged to receive a label (not shown) therein. A panel 92, which may be made of transparent plastic material, is constructed and arranged to cover the channel 90 so as to retain the label therein. In this embodiment, the channel 90 is provided with openings 94 (only one is shown in this Figure) constructed and arranged to receive resilient engaging members 96 located on the panel 92. Thus, in one embodiment, the panel 92 may be snap fittingly engaged to the base portion 82 by pushing the panel 92 against the base portion 82 until the engaging members 96 snap into the openings 94. Furthermore, the panel 92 may be removed from the channel 90 by pushing in the engaging members 96 and then lifting the panel 92 from the channel 90. This example, however, is not intended to be limiting and it is contemplated that the panel may have other configurations, size, or location and may be attached to the base portion 82 using other attachment mechanisms.

FIG. 9a shows a detailed view of the cover portion 12 and the retainer/lock 26. The spine portion 14 of the cover 12 may be disposed on the base portion 82 of the retainer/lock 26. In such a position, the first and second retaining structures 86, 88 may be received in openings 98 provided in the spine portion 14 of the cover 12. Accordingly, in embodiments having three pairs of first and retaining structures 86, 88, three openings 98 corresponding to the pairs of retaining structures 86, 88 may be provided on the spine portion 14 of the cover 12. Openings 100 may be formed on the cover leaf portions 16 of the cover 12. The openings 100 may be constructed and arranged to receive the first and second retaining fingers 22a, 22b when the cover 12 is in the closed position, as shown in FIG. 10a. Accordingly, the openings 100 may be aligned with and may correspond with the pairs of first and second retaining fingers 22a, 22b. Cutouts 89 may also be formed in the cover 12 to accommodate the first and second binding elements 18, 20 and the side portion 84 of the retainer/lock 26.

FIG. 9b shows the binder assembly 10 with the retainer/lock 26 releasably attached to the first and second binding elements 18, 20 in the closed position. The spine portion 14 of the cover 12 is retained between the retainer/lock 26 and the first and second binding elements 18, 20. The retainer/lock 26 is engaged with the first and second binding elements 18, 20 to secure the first and second binding elements 18, 20 in the closed position. Thus, these modular components may be assembled and securely connected to form the binder assembly 10.

As shown in FIG. 10b, the binder assemblies 10 may be stacked on top of one another. The covers 12 may either be made of plastic, cardboard, other materials, or a combination thereof. The covers 12 may be made of flexible, rigid, or semi-rigid materials, depending on the user's needs. The binding elements 18, 20, the covers 12, and the retainer/lock 26 may be made in various sizes to form the binder assemblies 10 with varying thickness and size.

The binder assembly 10 may be assembled in accordance with an embodiment as follows. The binding elements 18, 20 may initially be unassembled and in the open position as shown in FIG. 2b. In the illustrated position, the fingers 22a are aligned with the fingers 22b and the protrusions 28a, 28b are aligned with the protrusion receiving structures 30b, 30a, respectively. Furthermore, the first end 32a of the first binding element 18 may be aligned with the second end 34b of the second binding element 20, and the second end 34a of the first binding element 18 may be aligned with the first end 32b of the second binding element 20. The user may mount articles 11 to the binding elements 18 or 20 by inserting the retaining fingers 22a or 22b through the openings in the articles. The user may then manually move the first and second binding elements 18, 20 towards each other. As the first and second binding elements 18, 20 are pushed towards each other to the closed position, the locating pins 38a, 38b of the fingers 22a, 22b of each binding element 18, 20 may snap into the locating pin receiving structure 40a, 40b on the opposing fingers 22a, 22b of the other binding element 18, 20. The protrusions 28a, 28b of each binding element 18, 20 may then snap into the protrusion receiving structures 30a, 30b located on the other binding element 18, 20. That is, the protrusions 28a may snap into the protrusion receiving structures 30b and the protrusions 28b may snap into the protrusion receiving structures 30a. In one embodiment, the user may push the resilient protrusions 28a, 28b into the space 54 of the protrusion receiving structures 30a, 30b until the prongs 42a, 42b, 44a, 44b snap to retain the retaining structures (not shown) of the protrusion receiving structures 30a, 30b in the indentations 42a, 44a, 42b, 44b thereof. In the closed position, as shown in FIG. 3c, the divider 60 of the protrusion receiving structures 30a, 30b may be received in the space 45 between the prongs 42, 44b and the prongs 42a, 44a, respectively.

In addition, as shown in FIG. 5b, when the first and second binding elements 18, 20 are moved to the closed position, the protruding portions 70 of the first ends 32a, 32b are pushed towards the engaging members, taking the form of the vertical ridges 64 in this embodiment, of the second ends 34a, 34b. The resilient protruding portion 70 may be pushed until the ridge 72 formed on the protruding portion 70 snaps to engage with the ridge 64 provided on the second end 34a, 34b of the other binding element 18, 20, as shown in FIG. 5a. In the closed position, at least a portion of the protruding portion 70 of the first ends 32a, 32b may be disposed under the overhang 69 of the second ends 34a, 34b.

Alternatively, in the embodiment shown in FIG. 6a, the user may push the first ends 32a, 32b towards the second ends 34b, 34a until the sloped protrusion 78 of the second ends 34a, 34b snap into a recess (not shown) formed in the first ends 32a, 32b or engages with the ledge 76 to prevent the removal of the second ends 34a, 34b from the first ends 32b, 32a. Accordingly, the first and second binding elements 18, 20 may be in the closed position, as shown in FIG. 6b.

The cover 12 may be placed on the retainer/lock 26, as shown in FIG. 9a. The retaining structures 86, 88 may be inserted through the openings 98 formed in the spine portion 14 of the cover 12.

The retainer/lock 26 may be used to secure the first and second binding elements 18, 20 to the spine portion 14 of the cover 12 and to secure the connection between the first and second binding elements 18, 20 as follows. To attach the retainer/lock 26 to the first and second binding elements 18, 20, the retaining structures 86, 88 of the retainer/lock 26 with the cover 12 provided thereon (see FIG. 9a) may be pushed through the openings 29a, 29b formed in the first and second binding elements 18, 20 until the resilient retaining structures 86, 88 snap against the lower portions 39a, 39b of the first and binding elements 18, 20 to prevent the retaining structures 86, 88 from being removed from the openings 29a, 29b, as shown in FIG. 7b (cover 12 not shown in this Figure). In such an arrangement, the side portions 84 of the retainer/lock 26 prevent access to the first and second ends 32a, 32b, 34a, 34b, thus preventing the first and second binding elements 18, 20 from being disengaged by prying or lifting the first and second ends 32a, 33b, 34a, 34b. The binder assembly 10 may thus be in the assembled configuration wherein the retainer/lock 26 is attached to the first and second binding elements 18, and 20 and the cover 12 is retained between the retainer/lock 18 and the first and second binding elements 18, 20, as shown in FIG. 1.

The binder assembly 10 may be disassembled in accordance with an embodiment as follows. The user may pull the retainer/lock 26 from the first and second binding element 18, 20 with sufficient force to flex the resilient retaining structures 86, 88 such that the resilient retaining structures 86, 88 are removed from the openings 29a, 29b. Accordingly, the first and second ends 32a, 32b, 34a, 34b are accessible by the user. In one embodiment, the user may then pull on the lip 61 of the first ends 34a, 34b away from their associated second ends 34b, 34a such that the vertical ridges 64 of the second ends 34a, 34b are removed from engagement with the ridges 72 provided on their associated first ends 32b, 34a. Alternatively, in the embodiment shown in FIG. 6a, the lip 61 of the second ends 34a, 34b may be pulled away from their associated first ends 32a, 32b until the sloped protrusion 78 is no longer engaged with the ledge 76 or a recess (not shown) formed in the first ends 32a, 32b. Accordingly, the first and second binding elements 18, 20 may be pulled apart to the open position such that the locating pins 38a, 38b of the fingers 22a, 22b of each binding element 18, 20 are removed from the locating pin receiving structure 40a, 40b on the opposing fingers 22a, 22b of the other binding element 18, 20. In addition, the protrusions 28a, 28b of each binding element 18, 20 may then be removed from the protrusion receiving structures 30a, 30b located on the other binding element 18, 20. In particular, the resilient prongs 42a, 42b, 44a, 44b, of each binding element 18, 20 may snap out of their engagement with the retaining structures (not shown) provided on the side walls 56 of the protrusion receiving structures 30a, 30b on the other binding element 18, 20. As a result, the first and second binder elements 18, 20 may be in the open position wherein articles may be removed or mounted thereto.

While the principles of the invention have been made clear in the illustrative embodiments set forth above, it will be apparent to those skilled in the art that various modifications may be made to the structure, arrangement, proportion, elements, materials, and components used in the practice of the invention.

It will thus be seen that the objects of this invention have been fully and effectively accomplished. It will be realized, however, that the foregoing preferred specific embodiments have been shown and described for the purpose of illustrating the functional and structural principles of this invention and are subject to change without departure from such principles. Therefore, this invention includes all modifications encompassed within the spirit and scope of the following claims.

1. A binder assembly for receiving and retaining at least one article with holes formed along an edge thereof, the binder assembly comprising:
a cover comprising a spine portion and at least one cover leaf portion;
a first binder element comprising a plurality of first retaining fingers;
a second binder element comprising a plurality of second retaining fingers, the plurality of first and second retaining fingers being arranged to define a plurality of opposing pairs of the first and second retaining fingers,
the first binding element and the second binding element being moveable between 1) an open position wherein ends of the first and second retaining fingers of each pair are disengaged and spaced apart from one another to permit the at least one article to be removed from or mounted to the binder assembly by engaging or disengaging the holes and the first and second retaining fingers, and 2) a closed position wherein the ends of the first and second retaining fingers of each pair are engaged together to prevent the at least one article mounted to the binder assembly from being removed; and
an elongated retainer/lock constructed to releasably attach to the first and second binding elements in the closed position thereof with the spine portion of the cover therebetween for locking the first and second binding elements in the closed position and securing the first and second binding elements to the spine portion of the cover.

2. The binder assembly of claim 1, wherein the first and second binding elements each comprises a plurality of locking protrusions constructed and arranged to engage with a plurality of protrusion receiving structures on the opposing first and second binding elements.

3. The binder assembly of claim 2, wherein the first and second binding elements are constructed and arranged to engage with one other by snap fitting the locking protrusions with the plurality of protrusion receiving structures.

4. The binder assembly of claim 2, wherein the plurality of locking protrusions and the plurality of protrusion receiving structures of the first and second binding elements are constructed and arranged such that when the first and second binding elements are positioned to be moved to the engaged position, the plurality of locking protrusions of each of the first and second binder elements are aligned with the plurality of locking protrusions of the other of the first and second binder elements.

5. The binder assembly of claim 2, wherein each locking protrusion comprises two prongs and each protrusion receiving structure comprises an opening constructed and arranged to receive the two prongs of the locking protrusion.

6. The binder assembly of claim 1, wherein the first and second binding elements are constructed and arranged to have the same configuration.

7. The binder assembly of claim 1, wherein the elongated retainer/lock comprises a plurality of protrusions, and wherein the first and second binding elements each comprise a plurality of openings constructed and arranged to engage with the protrusions of the elongated retainer/lock.

8. The binder assembly of claim 7, wherein the spine portion of the cover comprises openings constructed and arranged to receive the plurality of protrusions of the elongated retainer/lock such that the cover is retained between the elongated retainer/lock and the first and second binding elements when the elongated retainer/lock is engaged with the first and second binding elements.

9. The binder assembly of claim 1, wherein the first and second binder elements each comprise a first end and a second end, the first retaining fingers located between the first and second end of the first binder element and the second retaining fingers located between the first and second end of the second binder element.

10. The binder assembly of claim 9, wherein the first end of each of the first and second binder elements comprises a first locking tab and the second end of each of the first and second binder elements comprises a second locking tab constructed and arranged to engage with the first locking tab of the other of the first and second binder elements.

11. The binder assembly of claim 10, wherein the first and second locking tabs of the first and second binding elements each comprises a resilient material.

12. The binder assembly of claim 1, wherein each of the first and second retaining fingers take the form of ring segments.

13. The binder assembly of claim 12, wherein in the engaged position, the opposing pairs of first and second retaining fingers take the form of rings.

14. The binder assembly of claim 1, wherein the cover comprises two cover leaf portions constructed and arranged to hold the articles therebetween when the cover is retained between the elongated retainer/lock and the first and second binding elements.

15. The binder assembly of claim 1, wherein each cover leaf portion comprises a plurality of recesses constructed and arranged to receive the first and second retaining fingers.

16. The binder assembly of claim 1, further comprising a transparent panel constructed and arranged to engage with the elongated retainer/lock.

17. A binder assembly for receiving and retaining at least one article with holes formed along an edge thereof, the binder assembly connectable to a cover having a spine portion and at least one cover leaf portion, the binder assembly comprising:
a first binder element comprising a plurality of first retaining fingers;
a second binder element comprising a plurality of second retaining fingers, the plurality of first and second retaining fingers being arranged to define a plurality of opposing pairs of the first and second retaining fingers,
the first binding element and the second binding element being moveable between 1) an open position wherein ends of the first and second retaining fingers of each pair are disengaged and spaced apart from one another to permit the at least one article to be removed from or mounted to the binder assembly by engaging or disengaging the holes and the first and second retaining fingers, and 2) a closed position wherein the ends of the first and second retaining fingers of each pair are engaged together to prevent the at least one article mounted to the binder assembly from being removed; and
an elongated retainer/lock constructed to releasably attach to the first and second binding elements in the closed position thereof with the spine portion of the cover therebetween for locking the first and second binding elements in the closed position and securing the first and second binding elements to the spine portion of the cover.

18. The binder assembly of claim 17, wherein the first and second binding elements each comprises a plurality of locking protrusions constructed and arranged to engage with a plurality of protrusion receiving structures on the opposing first and second binding elements.

19. The binder assembly of claim 18, wherein the first and second binding elements are constructed and arranged to engage with one other by snap fitting the locking protrusions with the plurality of protrusion receiving structures.

20. The binder assembly of claim 18, wherein the plurality of locking protrusions and the plurality of protrusion receiving structures of the first and second binding elements are constructed and arranged such that when the first and second binding elements are positioned to be moved to the engaged position, the plurality of locking protrusions of each of the first and second binder elements are aligned with the plurality of locking protrusions of the other of the first and second binder elements.

21. The binder assembly of claim 18, wherein each locking protrusion comprises two prongs and each protrusion receiving structure comprises an opening constructed and arranged to receive the two prongs of the locking protrusion.

22. The binder assembly of claim 17, wherein the first and second binding elements are constructed and arranged to have the same configuration.

23. The binder assembly of claim 17, wherein the elongated retainer/lock comprises a plurality of protrusions, and wherein the first and second binding elements each comprise a plurality of openings constructed and arranged to engage with the protrusions of the elongated retainer/lock.

24. The binder assembly of claim 23, wherein the plurality of protrusions of the elongated retainer/lock are received in openings formed in the spine portion of the cover such that the cover is retained between the elongated retainer/lock and the first and second binding elements when the elongated retainer/lock is engaged with the first and second binding elements.

25. The binder assembly of claim 17, wherein the first and second binder elements each comprise a first end and a second end, the first retaining fingers located between the first and second end of the first binder element and the second retaining fingers located between the first and second end of the second binder element.

26. The binder assembly of claim 25, wherein the first end of each of the first and second binder elements comprises a first locking tab and the second end of each of the first and second binder elements comprises a second locking tab constructed and arranged to engage with the first locking tab of the other of the first and second binder elements.

27. The binder assembly of claim 26, wherein the first and second locking tabs of the first and second binding elements each comprises a resilient material.

28. The binder assembly of claim 17, wherein each of the first and second retaining fingers take the form of ring segments.

29. The binder assembly of claim 28, wherein in the engaged position, the opposing pairs of first and second retaining fingers take the form of rings.

30. The binder assembly of claim 17, further comprising a transparent panel constructed and arranged to engage with the elongated retainer/lock.
